(19) United States
(12) Patent Application Publication
(10) Pub. No.: US 2025/0296509 A1
(43) Pub. Date: Sep. 25, 2025

(54) VEHICLE STEP DEVICE

(71) Applicant: AISIN CORPORATION, Kariya (JP)

(72) Inventors: Kazuhito NAKAJIMA, Kariya-shi (JP); Masashi MIWA, Kariya-shi (JP); Takahiro IGAUE, Kariya-shi (JP); Natsuki ITO, Kariya-shi (JP); Kimihiro SEKINE, Kariya-shi (JP)

(73) Assignee: AISIN CORPORATION, Kariya (JP)

(21) Appl. No.: 19/081,302

(22) Filed: Mar. 17, 2025

(30) Foreign Application Priority Data
Mar. 22, 2024 (JP) 2024-046925

(51) Int. Cl. B60R 3/02

(52) U.S. Cl. CPC B60R 3/02

(57) ABSTRACT

A vehicle step device attached to a vehicle includes a step provided to be movable with respect to the vehicle; a step side contact unit provided in the step; and a vehicle side contact unit provided on the vehicle and configured to come into contact with the step side contact unit. When the step is moved from the vehicle to a deployed position, the step side contact unit and the vehicle side contact unit overlap each other in a plan view such that at least a part of the vehicle side contact unit is positioned below the step side contact unit.

### CROSS REFERENCE TO RELATED APPLICATIONS

This application is based on and claims priority under 35 U.S.C. § 119 to Japanese Patent Application 2024-046925, filed on Mar. 22, 2024, the entire content of which is incorporated herein by reference.

### TECHNICAL FIELD

This disclosure relates to a vehicle step device.

### BACKGROUND DISCUSSION

A vehicle step device provided in a vehicle is known. A vehicle step device described in JP 2020-82916A (Reference 1) includes a step and a support mechanism that supports the step with respect to a vehicle body. A step plate moves from a storage position to a deployed position (called a use position in the document) by an operation of the support mechanism.

The step may be inclined with a portion supported by the support mechanism as a fulcrum. For example, when a load is applied to an outer edge of the step in a vehicle width direction, the step is inclined with a line along a vehicle front-rear direction as a central axis. When the step is largely inclined, a foot becomes unstable, and thus it is difficult to get on and off.

### SUMMARY

According to an aspect of this disclosure, a vehicle step device attached to a vehicle includes: a step provided to be movable with respect to the vehicle; a step side contact unit provided in the step; and a vehicle side contact unit provided on the vehicle and configured to come into contact with the step side contact unit. When the step is moved from the vehicle to a deployed position, the step side contact unit and the vehicle side contact unit overlap each other in a plan view such that at least a part of the vehicle side contact unit is positioned below the step side contact unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a partial schematic view of a vehicle including a vehicle step device;

FIG. 2 is a perspective view of the vehicle step device in a state where a step is positioned at a storage position;

FIG. 3 is a perspective view of the vehicle step device in a state where the step is positioned at a deployed position;

FIG. 4 is a perspective view of an arm and a frame of the vehicle step device in FIG. 1;

FIG. 5 is a perspective view of a bracket of the vehicle step device in FIG. 1 as viewed from below;

FIG. 6 is a plan view of the arm and the step of the vehicle step device in FIG. 1;

FIG. 7 is a plan view of a step side contact unit and a vehicle side contact unit of the vehicle step device in FIG. 1;

FIG. 8 is a perspective view of the step side contact unit and the vehicle side contact unit of the vehicle step device in FIG. 1;

FIG. 9 is a cross-sectional view of the step side contact unit and the vehicle side contact unit taken along a line 9-9 in FIG. 8;

FIG. 10 is a plan view of a step, a step side contact unit, and a vehicle side contact unit in a first modification of the vehicle step device in FIG. 1;

FIG. 11 is a perspective view of a step side contact unit and a vehicle side contact unit in a second modification of the vehicle step device in FIG. 1;

FIG. 12 is a perspective view of a step side contact unit and a vehicle side contact unit in a third modification of the vehicle step device in FIG. 1; and

FIG. 13 is a perspective view of the step side contact unit and the vehicle side contact unit in the third modification of the vehicle step device in FIG. 1.

### DETAILED DESCRIPTION

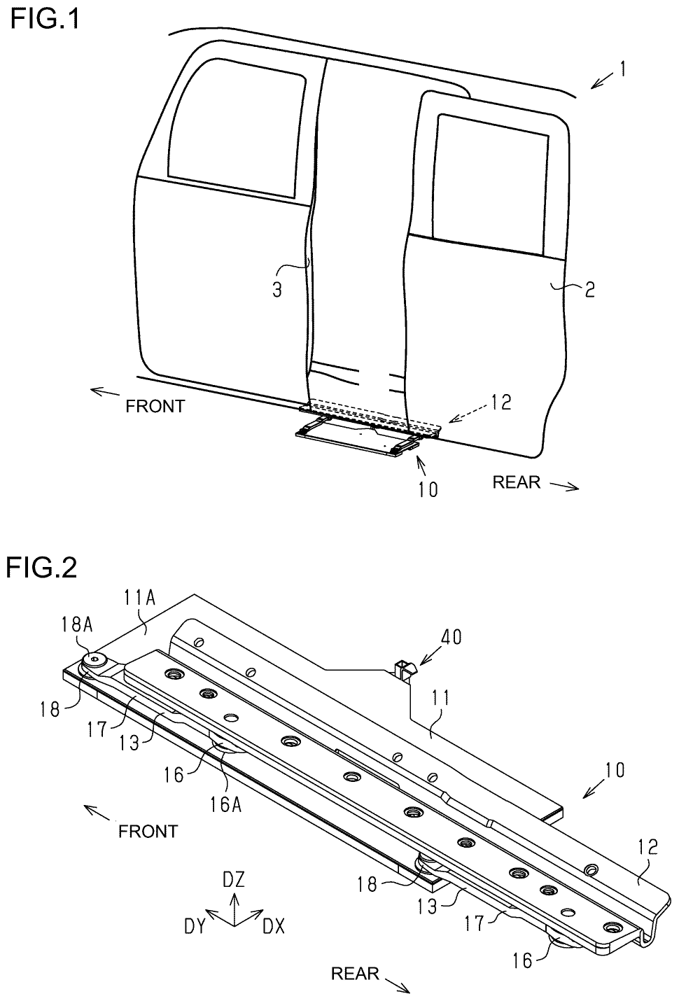

A vehicle step device 10 will be described below with reference to FIGS. 1 to 9.

In the following description, a state where the vehicle step device 10 is attached to a vehicle 1 is referred to as an “attachment state of the vehicle step device 10”. Directions of the vehicle step device 10 are defined in the attachment state of the vehicle step device 10. Specifically, a front-rear direction of the vehicle step device 10 coincides with a vehicle front-rear direction DY of the vehicle 1 in the attachment state of the vehicle step device 10. A width direction of the vehicle step device 10 coincides with a vehicle width direction DX in the attachment state of the vehicle step device 10. An up-down direction of the vehicle step device 10 coincides with a vehicle up-down direction DZ in the attachment state of the vehicle step device 10. In the embodiment, when a configuration of the vehicle step device 10 is described using directions, the directions are referred to as the vehicle front-rear direction DY, the vehicle width direction DX, and the vehicle up-down direction DZ. In the following description, an inner side in the vehicle width direction DX means being closer to a vehicle center than an object in the vehicle width direction DX.

In the embodiment, the vehicle 1 does not include the vehicle step device 10. The vehicle 1 includes at least a vehicle body. The vehicle body includes at least a rocker. The rocker constitutes a part of a framework of a side portion on a bottom portion of the vehicle 1.

As illustrated in FIG. 1, the vehicle step device 10 is attached to the vehicle 1. The vehicle step device 10 assists in getting on and off the vehicle 1. The vehicle step device 10 is provided below an opening 3 of the vehicle 1 that is closed by a vehicle door 2 for getting on and off the vehicle. A step 11 of the vehicle step device 10 may be used as an auxiliary table on which a leg is placed when a package is taken in and out of the vehicle 1. For example, the vehicle step device 10 may be provided below the opening 3 of the vehicle 1 closed by a back door.

### Configuration of Vehicle Step Device 10

The vehicle step device 10 includes the step 11, a step side contact unit 40, and a vehicle side contact unit 50. The vehicle step device 10 includes a bracket 12 fixed to the vehicle 1. The bracket 12 is fixed to the rocker of the vehicle 1. The vehicle step device 10 includes a plurality of arms 13 that support the step 11. In the embodiment, the vehicle step device 10 includes two arms 13.

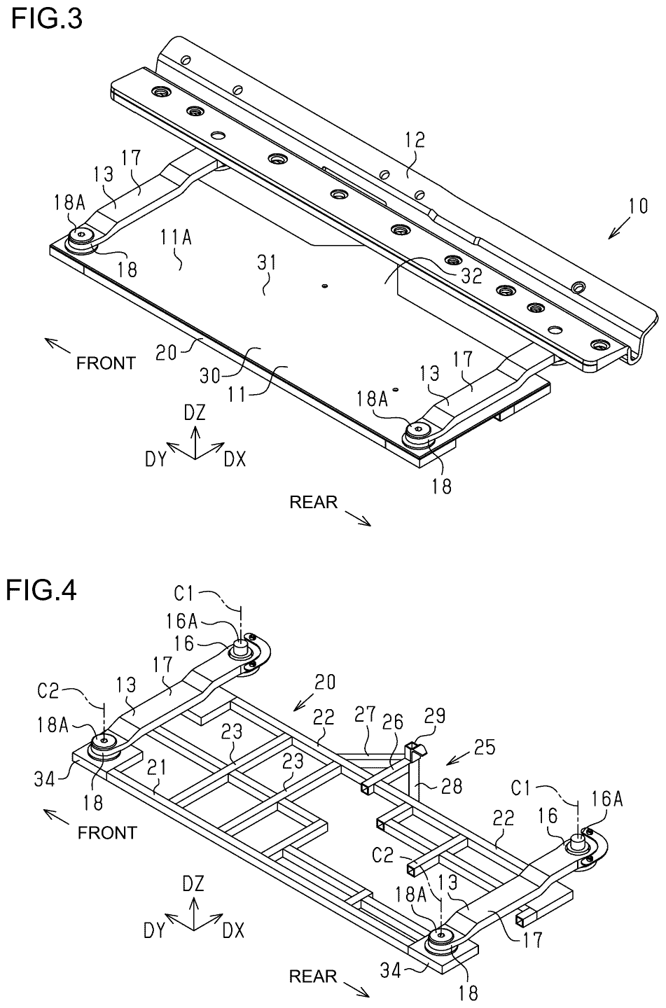

As illustrated in FIGS. 2 and 3, in the vehicle step device 10, the step 11 moves. The step 11 moves with respect to the vehicle 1. The step 11 moves between a storage position (see FIG. 2 and later described) and a deployed position (see FIG. 3 and later described).

### Arm 13

One of the two arms 13 supports a front portion of the step 11. The other one of the two arms 13 supports a rear portion of the step 11. The two arms 13 are disposed at an interval in the vehicle front-rear direction DY. The two arms 13 are disposed parallel to each other in a plan view.

The arm 13 is connected to the vehicle 1 and the step 11. The arm 13 includes a base portion 16, an extension portion 17 extending from the base portion 16, and a tip end portion 18 provided at a tip end of the extension portion 17. The base portion 16 of the arm 13 is attached to the bracket 12 such that the arm 13 can rotate with respect to the bracket 12 about a first rotation axis C1 passing through the base portion 16. In one example, the base portion 16 of the arm 13 is attached to the bracket 12 via a first shaft member 16A. The base portion 16 of the arm 13 is disposed on a bottom surface of the bracket 12.

The tip end portion 18 of the arm 13 is attached to the step 11 such that the arm 13 can rotate with respect to the step 11 about a second rotation axis C2 passing through the tip end portion 18. In one example, the tip end portion 18 of the arm 13 is attached to the step 11 via a second shaft member 18A. The tip end portion 18 of the arm 13 is disposed on an upper surface of the step 11.

The arm 13 moves the step 11 toward the deployed position in the vehicle width direction DX with respect to the vehicle 1 in the plan view. The arm 13 moves the step 11 from the storage position to the deployed position in the vehicle width direction DX with respect to the vehicle 1 in the plan view. In the embodiment, the step 11 moves in the vehicle front-rear direction DY while moving in the vehicle width direction DX with respect to the vehicle 1 by the rotation of the arm 13.

When the step 11 is positioned at the storage position (see FIG. 2), at least a half of the step 11 on the vehicle side is hidden by the vehicle 1 in the plan view. When the step 11 is positioned at the storage position, at least an intermediate portion 11A of the step 11 in the vehicle width direction DX is disposed below the bracket 12.

When the step 11 is positioned at the deployed position (see FIG. 3), the step 11 is positioned outward away from the storage position (see FIG. 1) with respect to the vehicle 1 in the vehicle width direction DX. When the step 11 is positioned at the deployed position, the intermediate portion 11A of the step 11 in the vehicle width direction DX is exposed from the vehicle 1 in the plan view. In the embodiment, the deployed position is positioned rearward of the storage position. In another example, the deployed position may be positioned in front of the storage position.

When the step 11 is positioned at the storage position, the tip end of the arm 13 is positioned below the vehicle 1 or near a side surface of the vehicle 1 in the plan view. When the step 11 is positioned at the deployed position, the tip end of the arm 13 is positioned away from the side surface of the vehicle 1 in the vehicle width direction DX in the plan view.

### Step 11

The step 11 includes a frame 20 and a cover board 30 disposed on the frame 20. The frame 20 is formed of a metal square pipe. Bending of the step 11 is limited by the frame 20.

As illustrated in FIG. 4, the frame 20 includes a first longitudinal frame member 21 extending in the vehicle front-rear direction DY, second longitudinal frame members 22 disposed on the vehicle side of the first longitudinal frame member 21 in the vehicle width direction DX, and lateral frame members 23 connecting the first longitudinal frame member 21 and the second longitudinal frame members 22. In the embodiment, the frame 20 includes two second longitudinal frame members 22 linearly disposed in the vehicle front-rear direction DY. The two second longitudinal frame members 22 are disposed parallel to the first longitudinal frame member 21. When the two second longitudinal frame members 22 are distinguished from each other, the second longitudinal frame member 22 positioned on a front side is referred to as a front side second longitudinal frame member 22, and the second longitudinal frame member 22 positioned on a rear side is referred to as a rear side second longitudinal frame member 22.

The frame 20 is provided with a contact frame portion 25. The contact frame portion 25 constitutes a framework of the step side contact unit 40. The contact frame portion 25 is provided on the second longitudinal frame members 22 so as to protrude from the second longitudinal frame members 22 toward the vehicle center in the vehicle width direction DX. The contact frame portion 25 includes a first frame member 26 orthogonal to the second longitudinal frame member 22, a second frame member 27 disposed in front of the first frame member 26, a third frame member 28 disposed behind the first frame member 26, and a fourth frame member 29 extending in the vehicle up-down direction DZ.

The second frame member 27 extends rearward from the front side second longitudinal frame member 22 and toward the vehicle center in the vehicle width direction DX, and is joined to the front side second longitudinal frame member 22 and the first frame member 26.

The third frame member 28 extends forward from the rear side second longitudinal frame member 22 and toward the vehicle center in the vehicle width direction DX, and is joined to the rear side second longitudinal frame member 22 and the first frame member 26.

The fourth frame member 29 is provided at an end portion of the first frame member 26 on the vehicle side. The fourth frame member 29 extends upward so as to be orthogonal to the first frame member 26.

The cover board 30 is formed to cover the frame 20 and the contact frame portion 25. The cover board 30 includes a rectangular board body 31 that covers the frame 20 and a board protrusion 32 that covers the contact frame portion 25. The cover board 30 is made of a resin or a metal.

The step 11 includes two step support portions 34. The step support portion 34 is a portion supported by the arm 13 in the step 11. The step support portion 34 is fixed to the frame 20. In the embodiment, the step support portion 34 is formed as a portion that supports the second shaft member 18A. The step support portion 34 has a hole through which the second shaft member 18A is inserted. The second shaft member 18A is provided on the step support portion 34 in a state of being inserted into the hole.

The two step support portions 34 are respectively positioned farther from the vehicle 1 in the vehicle width direction DX than the step side contact unit 40 in the step 11. One of the two step support portions 34 is disposed in front of the step side contact unit 40 in the step 11. The other one of the two step support portions 34 is disposed behind the step side contact unit 40 in the step 11. The two step support portions 34 are respectively provided at positions at an equal distance from the step side contact unit 40.

As illustrated in FIG. 6, in the embodiment, the two step support portions 34 are respectively disposed at positions farther from the vehicle 1 than an intermediate line ML in the vehicle width direction DX in the step 11. One of the two step support portions 34 is provided at a corner portion of an outer front end of the step 11. The other one of the two step support portions 34 is provided at a corner portion of an outer rear end of the step 11.

### Bracket 12

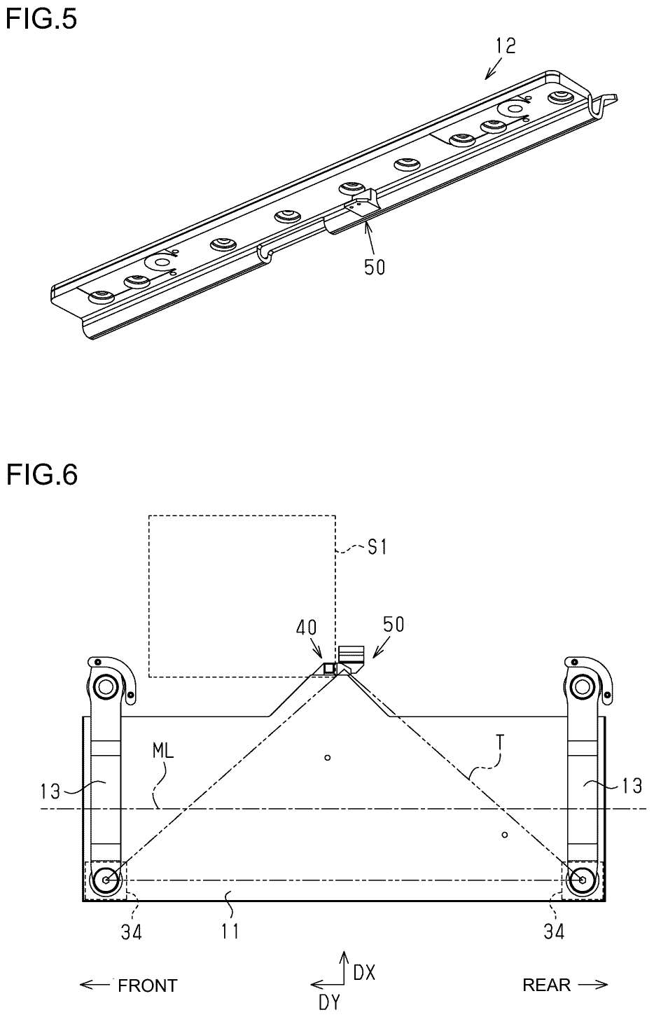

As illustrated in FIG. 5, the bracket 12 has a structure corresponding to a bottom surface structure of the rocker. The vehicle side contact unit 50 is provided on a lower surface of the bracket 12.

### Step Side Contact Unit 40

The step side contact unit 40 will be described with reference to FIGS. 6 to 9.

The step side contact unit 40 is provided in the step 11. The step side contact unit 40 overlaps the vehicle side contact unit 50 in the plan view in a state where the step 11 is positioned at the deployed position. Hereinafter, a specific example will be described.

As illustrated in FIG. 6, the step side contact unit 40 is provided on the vehicle side in the vehicle width direction DX in the step 11. The step side contact unit 40 is provided at a position between the two step support portions 34 in the vehicle front-rear direction DY in the step 11. In the embodiment, the step side contact unit 40 is disposed at an intermediate position in the vehicle front-rear direction DY in the step 11. The step side contact unit 40 is provided at a position at an equal distance from the two step support portions 34.

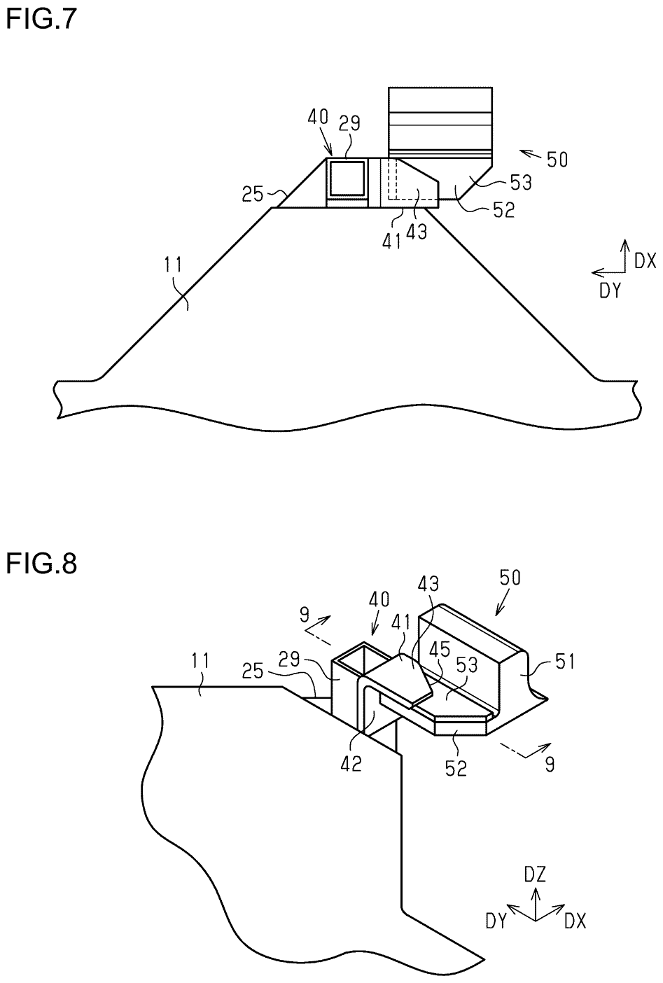

As illustrated in FIGS. 7 and 8, the step side contact unit 40 is configured such that at least a part of the step side contact unit 40 is positioned above the vehicle side contact unit 50 when the step 11 is positioned at the deployed position. The step side contact unit 40 includes a first contactable portion 43 with which the vehicle side contact unit 50 comes into contact in a state where the step 11 is positioned at the deployed position. The first contactable portion 43 is configured as a part of a step engagement portion 41 described later.

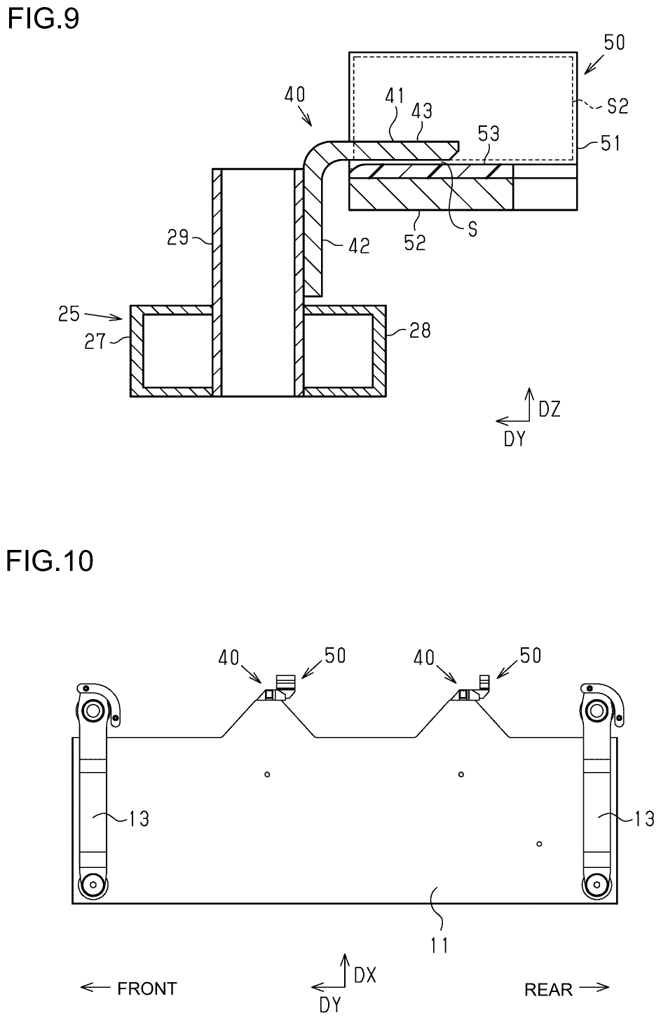

As illustrated in FIGS. 8 and 9, the step side contact unit 40 includes the contact frame portion 25 (described above), which is provided on the frame 20, and the step engagement portion 41. The step engagement portion 41 is fixed to the fourth frame member 29 of the contact frame portion 25. The step engagement portion 41 includes a fixing portion 42, which is fixed to the fourth frame member 29, and the first contactable portion 43. The first contactable portion 43 is positioned above the cover board 30 of the step 11. The first contactable portion 43 extends rearward from the fixing portion 42 in the plan view.

As illustrated in FIG. 8, a taper 45 is provided at a rear portion of the first contactable portion 43 on the vehicle side. When the step 11 moves, interference between the first contactable portion 43 and a vehicle engagement portion 52 of the vehicle side contact unit 50 is avoided by the taper 45.

The step engagement portion 41 is configured such that the first contactable portion 43 of the step engagement portion 41 is positioned above a first contact portion 53 of the vehicle engagement portion 52 when the step 11 is disposed at the deployed position. When the step 11 is disposed at the deployed position, the first contactable portion 43 of the step engagement portion 41 may be in contact with the first contact portion 53 of the vehicle engagement portion 52, or may be disposed with a gap S from the first contact portion 53 of the vehicle engagement portion 52. When the gap S is provided between the first contactable portion 43 of the step engagement portion 41 and the first contact portion 53 of the vehicle engagement portion 52, a size of the gap S is smaller than a movement distance of the first contactable portion 43 when the step 11 is most largely inclined in a case where the vehicle engagement portion 52 is not provided.

### Vehicle Side Contact Unit 50

The vehicle side contact unit 50 will be described with reference to FIGS. 6 to 9. The vehicle side contact unit 50 is provided in the vehicle 1. The vehicle side contact unit 50 is configured to come into contact with the step side contact unit 40. The vehicle side contact unit 50 overlaps the step side contact unit 40 in the plan view in a state where the step 11 is positioned at the deployed position.

As illustrated in FIGS. 7 and 8, the vehicle side contact unit 50 is configured such that at least a part of the vehicle side contact unit 50 is positioned below the step side contact unit 40 when the step 11 is positioned at the deployed position. Specifically, the vehicle side contact unit 50 includes the first contact portion 53. The first contact portion 53 is positioned below the first contactable portion 43 of the step side contact unit 40 in a state where the step 11 is positioned at the deployed position. The first contact portion 53 is configured as a part of the vehicle engagement portion 52 described later.

As illustrated in FIGS. 8 and 9, the vehicle side contact unit 50 includes a fixing portion 51, which is provided on the bracket 12, and the vehicle engagement portion 52. The fixing portion 51 extends downward from a bottom portion of the bracket 12. The vehicle engagement portion 52 is fixed to a lower end of the fixing portion 51. The vehicle engagement portion 52 extends, from the lower end of the fixing portion 51 in the plan view, in a direction away from the vehicle center in the vehicle width direction DX. The vehicle engagement portion 52 is provided with the first contact portion 53.

The vehicle engagement portion 52 is configured such that the first contact portion 53 of the vehicle engagement portion 52 is positioned below the first contactable portion 43 of the step engagement portion 41 when the step 11 is disposed at the deployed position. At this time, the first contact portion 53 of the vehicle engagement portion 52 may be in contact with the first contactable portion 43 of the step engagement portion 41, or may be disposed with the gap S from the first contactable portion 43 of the step engagement portion 41.

In the embodiment, when the step 11 moves from the storage position to the deployed position, the step engagement portion 41, which is positioned in front of the vehicle engagement portion 52 and on an inner side in the vehicle width direction DX, moves toward the vehicle engagement portion 52. In the plan view, the step engagement portion 41 enters the vehicle engagement portion 52 from the front and the inner side in the vehicle width direction DX, and is disposed at a position overlapping the vehicle engagement portion 52. Therefore, a first space S1 (see FIG. 6) through which the step engagement portion 41 passes is provided in front of the vehicle engagement portion 52. A second space S2 (see FIG. 9) into which the step engagement portion 41 can enter is provided in an upper portion of the vehicle engagement portion 52.

A portion of the first contact portion 53 of the vehicle engagement portion 52 that is in contact with the step engagement portion 41 is made of a metal, a resin, or a rubber. When the first contactable portion 43 of the step engagement portion 41 is made of a metal, a portion of the first contact portion 53 of the vehicle engagement portion 52 that is in contact with the step engagement portion 41 is made of an elastic member, for example, a resin or a rubber. When a portion of the first contactable portion 43 of the step engagement portion 41 that is in contact with the vehicle engagement portion 52 is made of an elastic member, the portion of the first contact portion 53 of the vehicle engagement portion 52 that is in contact with the step engagement portion 41 is made of a metal, a resin, or a rubber. With such a configuration, when the first contactable portion 43 of the step engagement portion 41 is in contact with the first contact portion 53 of the vehicle engagement portion 52, noise caused by the contact can be reduced.

### Operation

When the step 11 is positioned at the storage position, the tip end portion 18 of the arm 13 is positioned close to the base portion 16 of the arm 13 in the vehicle width direction DX. When the tip end portion 18 of the arm 13 moves away from the vehicle 1 in the vehicle width direction DX by the rotation of the arm 13 by a power, the step 11 moves. The step 11 may be moved by the power. In this case, the arm 13 rotates as the step 11 moves. When the step 11 is positioned at the deployed position, the step engagement portion 41 of the step 11 and the vehicle engagement portion 52 are engaged with each other.

Specifically, when the step 11 is moved from the storage position to the deployed position, the step side contact unit 40 and the vehicle side contact unit 50 overlap each other in the plan view such that at least a part of the vehicle side contact unit 50 is positioned below the step side contact unit 40. In a state where the step 11 is positioned at the deployed position, the step side contact unit 40 and the vehicle side contact unit 50 overlap each other in the plan view at a position between the two step support portions 34 in the vehicle front-rear direction DY.

### Operation of Embodiment

When the step 11 is positioned at the deployed position, the step 11 can be supported by the arms 13 at the step support portions 34 at two positions and can be supported by the vehicle 1 via the vehicle side contact unit 50. When a load is applied to the step 11 due to a person getting on or off or an animal getting on or off, forces are applied to three positions, that is, the step support portions 34 at two positions and the vehicle side contact unit 50, via the step 11. Since the step 11 is supported at three positions separated from each other, the step 11 is prevented from being largely inclined due to the load applied to the step 11. Therefore, ease of getting on and off is improved.

When the step 11 is positioned at the deployed position, the step side contact unit 40 and the vehicle side contact unit 50 overlap each other in the plan view. That is, while the step 11 is moving, the step side contact unit 40 is away from the vehicle side contact unit 50. Therefore, the step 11 moves smoothly.

### Effects of Embodiment

(1) The vehicle step device 10 includes the step side contact unit 40 provided in the step 11 and the vehicle side contact unit 50 configured to come into contact with the step side contact unit 40. When the step 11 is moved from the vehicle 1 to the deployed position, the step side contact unit 40 and the vehicle side contact unit 50 overlap each other in the plan view such that at least a part of the vehicle side contact unit 50 is positioned below the step side contact unit 40.

According to this configuration, when a load is applied to the step 11 moved to the deployed position and the step 11 is inclined, the step 11 is supported by the vehicle side contact unit 50. Accordingly, the step 11 is prevented from being largely inclined. Therefore, the step 11 in a state of being moved to the deployed position can be stabilized. Accordingly, since the step 11 is less likely to be unstable, a user can easily get on and off.

(2) In the vehicle step device 10, the step side contact unit 40 may be provided on the vehicle side in the vehicle width direction DX in the step 11. According to this configuration, it is possible to limit a portion of the step 11 on the vehicle side from sinking downward.

(3) In the vehicle step device 10, the step side contact unit 40 is provided at a position between the two step support portions 34 in the vehicle front-rear direction DY in the step 11. In a state where the step 11 is positioned at the deployed position, the step side contact unit 40 and the vehicle side contact unit 50 overlap each other in the plan view at a position between the two step support portions 34 in the vehicle front-rear direction DY.

According to this configuration, the step 11 can be supported at three positions of the two step support portions 34 and the portion positioned between the two step support portions 34 in the vehicle front-rear direction DY. Since the step 11 can be supported at the three positions in this manner, the bending of the step 11 can be limited as compared with a case where the step 11 is supported at two positions.

(4) In the vehicle step device 10, the step side contact unit 40 may be provided on the vehicle side in the vehicle width direction DX in the step 11. The two step support portions 34 may be respectively provided at positions in the step 11 farther from the vehicle 1 in the vehicle width direction DX than the step side contact unit 40 and at an equal distance from the step side contact unit 40.

According to this configuration, the step 11 can be supported at three positions of the two step support portions 34 and the portion positioned between the two step support portions 34 in the vehicle front-rear direction DY. Since the three positions are positioned at vertices of a triangle T (two-dot chain line in FIG. 6), the stability of the step 11 in a state of being moved to the deployed position can be improved.

(5) In the vehicle step device 10, the step 11 includes the frame 20. The two step support portions 34 and the step side contact unit 40 are provided on the frame 20. According to this configuration, since rigidity of the step 11 is improved by the frame 20, the bending of the step 11 is small when a load is locally applied on the step 11. Therefore, when the step 11 is used, it is easy to get on and off the vehicle 1.

### Modification

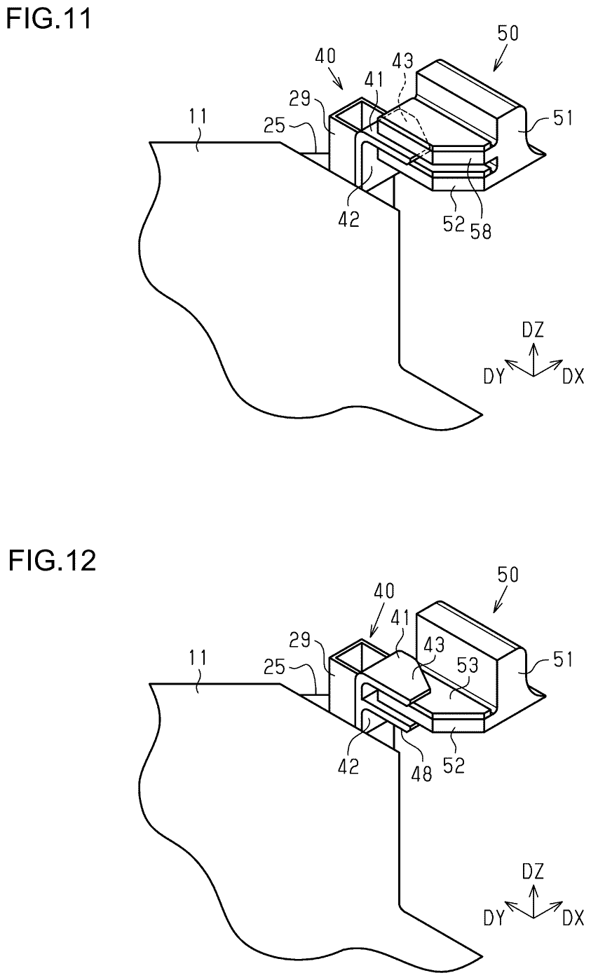

The embodiment can be modified as follows. The embodiment and the following modifications can be combined with one another without technical contradiction.
The step 11 may be manually moved. That is, the step 11 may be manually stored from a deployed position to a storage position, or may be manually moved from the storage position to the deployed position.
The step 11 may be moved by an operation of a drive device. A first example of the drive device moves the step 11 by rotating the arm 13 with a rotational power of a motor. A second example of the drive device moves the step 11 by a motor-driven telescopic actuator. A third example of the drive device moves the step 11 by rotating the arm 13 with a motor-driven telescopic actuator. A fourth example of the drive device operates the vehicle door 2 and engages the opening and closing of the vehicle door 2 and the opening and closing of the step 11.
As illustrated in FIG. 10, the vehicle step device 10 may include two or more sets of the step side contact unit 40 and the vehicle side contact unit 50. In the example illustrated in FIG. 10, in the step 11, the two step side contact units 40 are disposed between the two step support portions 34 in the vehicle front-rear direction DY. According to this configuration, when the step 11 is positioned at the deployed position, the step 11 is supported by the arms 13 at the two step support portions 34 and is supported by the vehicle side contact units 50 at two positions, and thus the stability of the step 11 is improved.
As illustrated in FIG. 11, the vehicle side contact unit 50 may include a portion disposed above and a portion disposed below the first contactable portion 43 of the step side contact unit 40 in a state where the step 11 is positioned at the deployed position. Hereinafter, an example of the vehicle side contact unit 50 will be described.

The vehicle side contact unit 50 includes the first contact portion 53 positioned below the first contactable portion 43 of the step side contact unit 40 in a state where the step 11 is positioned at the deployed position. The vehicle side contact unit 50 further includes a second contact portion 58 positioned above the first contactable portion 43 of the step side contact unit 40 in a state where the step 11 is positioned at the deployed position.

When a relatively large load is applied to a portion of the step 11 on the vehicle side in the vehicle width direction DX, the step 11 is inclined such that the step side contact unit 40 is lowered. In this case, the first contactable portion 43 of the step side contact unit 40 is in contact with the first contact portion 53 of the vehicle side contact unit 50.

When a relatively large load is applied to a portion of the step 11 on a side opposite to the vehicle side in the vehicle width direction DX, the step 11 is inclined such that the step side contact unit 40 rises. In this case, the first contactable portion 43 of the step side contact unit 40 is in contact with the second contact portion 58 of the vehicle side contact unit 50.

In either case, the inclination of the step 11 can be limited. Therefore, the step 11 at the deployed position can be stabilized.

In the above-described embodiment, in the step 11, the step side contact unit 40 is provided on the portion on the vehicle side in the vehicle width direction DX, and the two step support portions 34 are provided on the portion on the side opposite to the vehicle side in the vehicle width direction DX. In such a case, the step 11 is less likely to be inclined such that the step side contact unit 40 rises. Therefore, the second contact portion 58 of the vehicle side contact unit 50 may be omitted as in the embodiment.

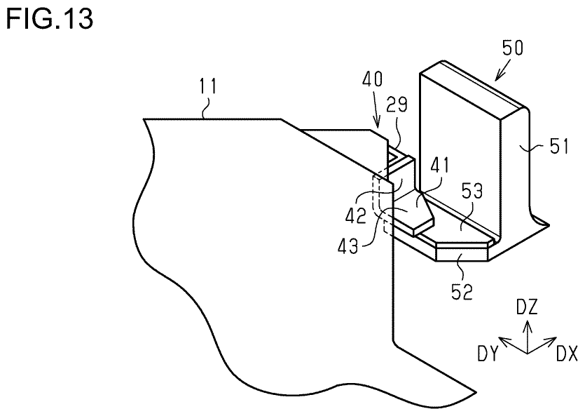

As illustrated in FIG. 12, the step side contact unit 40 may include a portion disposed above and a portion disposed below the first contact portion 53 of the vehicle side contact unit 50 in a state where the step 11 is positioned at the deployed position. Hereinafter, an example of the step side contact unit 40 will be described.

In the vehicle step device 10, the step side contact unit 40 includes the first contactable portion 43. The first contactable portion 43 of the step side contact unit 40 is positioned above the first contact portion 53 of the vehicle side contact unit 50 in a state where the step 11 is positioned at the deployed position. The step side contact unit 40 further includes a second contactable portion 48 positioned below the first contact portion 53 of the vehicle side contact unit 50 in a state where the step 11 is positioned at the deployed position.

When a relatively large load is applied to a portion of the step 11 on the vehicle side in the vehicle width direction DX, the step 11 is inclined such that the step side contact unit 40 is lowered. In this case, the first contactable portion 43 of the step side contact unit 40 is in contact with the first contact portion 53 of the vehicle side contact unit 50.

When a relatively large load is applied to a portion of the step 11 on a side opposite to the vehicle side in the vehicle width direction DX, the step 11 is inclined such that the step side contact unit 40 rises. In this case, the second contactable portion 48 of the step side contact unit 40 is in contact with the first contact portion 53 of the vehicle side contact unit 50 or is pressed by the first contact portion 53.

In either case, the inclination of the step 11 can be limited. Therefore, the step 11 in a state of being moved to the deployed position can be stabilized.

In the above-described embodiment, in the step 11, the step side contact unit 40 is provided on the portion on the vehicle side in the vehicle width direction DX, and the two step support portions 34 are provided on the portion on the side opposite to the vehicle side in the vehicle width direction DX. In such a case, the step 11 is less likely to be inclined such that the step side contact unit 40 rises. Therefore, the second contactable portion 48 of the step side contact unit 40 may be omitted as in the embodiment.

As illustrated in FIG. 13, in the vehicle step device 10, the first contactable portion 43 of the step engagement portion 41 of the step side contact unit 40 may be disposed at a position lower than the step 11. For example, when the step 11 is supported by the arm 13 from below, the step engagement portion 41 of the step side contact unit 40 may be disposed at a position lower than the step 11.

### Summary of Embodiments

A vehicle step device is attached to a vehicle. The vehicle step device includes: a step provided to be movable with respect to the vehicle; a step side contact unit provided in the step; and a vehicle side contact unit provided on the vehicle and configured to come into contact with the step side contact unit. By moving the step from the vehicle to a deployed position, the step side contact unit and the vehicle side contact unit overlap each other in a plan view such that at least a part of the vehicle side contact unit is positioned below the step side contact unit.

According to this configuration, when a load is applied to the step moved to the deployed position and the step is inclined, the step is supported by the vehicle side contact unit. Accordingly, the step 11 is prevented from being largely inclined. Therefore, the step in a state of being moved to the deployed position can be stabilized. Accordingly, since the step is less likely to be unstable, a user can easily get on and off.

In the vehicle step device, the step side contact unit may be provided on a vehicle side in a vehicle width direction in the step. According to this configuration, it is possible to limit a portion of the step on the vehicle side from sinking downward.

The vehicle step device includes two arms. The two arms are connected to the vehicle and the step and are configured to move the step in a vehicle width direction with respect to the vehicle in the plan view. The step includes two step support portions supported by the arms. The step side contact unit may be provided at a position between the two step support portions in a vehicle front-rear direction in the step. The step side contact unit and the vehicle side contact unit overlap each other in the plan view at a position between the two step support portions in the vehicle front-rear direction in a state where the step is positioned at the deployed position.

According to this configuration, the step can be supported at three positions of the two step support portions and the portion positioned between the two step support portions in the vehicle front-rear direction. Since the step can be supported at the three positions in this manner, the bending of the step can be limited as compared with a case where the step is supported at two positions.

In the vehicle step device, the step side contact unit may be provided on a vehicle side in a vehicle width direction in the step. The two step support portions are respectively provided at positions in the step farther from the vehicle in the vehicle width direction than the step side contact unit and at an equal distance from the step side contact unit.

According to this configuration, the step can be supported at three positions of the two step support portions and the portion positioned between the two step support portions in the vehicle front-rear direction. Since the three positions are positioned at vertices of a triangle, the stability of the step in a state of being moved to the deployed position can be improved.

In the vehicle step device, the step side contact unit includes a first contactable portion with which the vehicle side contact unit comes into contact in a state where the step is positioned at the deployed position. The vehicle side contact unit includes a first contact portion positioned below the first contactable portion of the step side contact unit in the state where the step is positioned at the deployed position. The vehicle side contact unit includes a second contact portion positioned above the first contactable portion of the step side contact unit in the state where the step is positioned at the deployed position.

According to this configuration, when the step side contact unit is inclined downward in the step, the first contactable portion of the step side contact unit is in contact with the first contact portion of the vehicle side contact unit or is pressed by the first contact portion. When the step side contact unit is inclined upward in the step, the first contactable portion of the step side contact unit is in contact with the second contact portion of the vehicle side contact unit or is pressed by the second contact portion. In either case, the inclination of the step can be limited. Therefore, the step in a state of being moved to the deployed position can be stabilized.

In the vehicle step device, the step side contact unit includes a first contactable portion with which the vehicle side contact unit comes into contact in a state where the step is positioned at the deployed position. The vehicle side contact unit includes a first contact portion positioned below the first contactable portion of the step side contact unit in the state where the step is positioned at the deployed position. The step side contact unit includes a second contactable portion positioned below the first contact portion of the vehicle side contact unit in the state where the step is positioned at the deployed position.

According to this configuration, when the step side contact unit is inclined downward in the step, the first contactable portion of the step side contact unit is in contact with the first contact portion of the vehicle side contact unit or is pressed by the first contact portion. When the step side contact unit is inclined upward in the step, the second contactable portion of the step side contact unit is in contact with the first contact portion of the vehicle side contact unit or is pressed by the first contact portion. In either case, the inclination of the step can be limited. Therefore, the step in a state of being moved to the deployed position can be stabilized.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle step device attached to a vehicle, the vehicle step device comprising:
a step provided to be movable with respect to the vehicle;
a step side contact unit provided in the step; and
a vehicle side contact unit provided on the vehicle and configured to come into contact with the step side contact unit, wherein
when the step is moved from the vehicle to a deployed position, the step side contact unit and the vehicle side contact unit overlap each other in a plan view such that at least a part of the vehicle side contact unit is positioned below the step side contact unit.

2. The vehicle step device according to claim 1, wherein
the step side contact unit is provided on a vehicle side in a vehicle width direction in the step.

3. The vehicle step device according to claim 1, further comprising:
two arms connected to the vehicle and the step and configured to move the step in a vehicle width direction with respect to the vehicle in the plan view, wherein
the step includes two step support portions supported by the arms,
the step side contact unit is provided at a position between the two step support portions in a vehicle front-rear direction in the step, and
the step side contact unit and the vehicle side contact unit overlap each other in the plan view at a position between the two step support portions in the vehicle front-rear direction in a state where the step is positioned at the deployed position.

4. The vehicle step device according to claim 3, wherein
the step side contact unit is provided on a vehicle side in the vehicle width direction in the step, and
the two step support portions are respectively provided at positions in the step farther from the vehicle in the vehicle width direction than the step side contact unit and at an equal distance from the step side contact unit.

5. The vehicle step device according to claim 1, wherein
the step side contact unit includes a first contactable portion with which the vehicle side contact unit comes into contact in a state where the step is positioned at the deployed position,
the vehicle side contact unit includes a first contact portion positioned below the first contactable portion of the step side contact unit in the state where the step is positioned at the deployed position, and
the vehicle side contact unit includes a second contact portion positioned above the first contactable portion of the step side contact unit in the state where the step is positioned at the deployed position, or
the step side contact unit includes a second contactable portion positioned below the first contact portion of the vehicle side contact unit in the state where the step is positioned at the deployed position.
